(19) United States
(12) Patent Application Publication
(10) Pub. No.: US 2011/0122158 A1
(43) Pub. Date: May 26, 2011

(54) DISPLAY ADJUSTMENT SYSTEM AND METHOD FOR MEDIA PLAYER

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/727,245

(22) Filed: Mar. 19, 2010

(30) Foreign Application Priority Data
Nov. 20, 2009 (CN) 200910310160.5

(51) Int. Cl. G09G 5/00

(52) U.S. Cl. 345/672; 345/156

(57) ABSTRACT

A display adjustment system includes a sensor and a processing unit. The sensor is mounted to a media player to measure changes in position of the media player and output measurement results correspondingly. The processing unit receives the measurement results to obtain an angle of inclination of the media player corresponding to a datum plane, and processes an image according to the angle of inclination. The processed image is displayed by the media player.

### BACKGROUND

1. Technical Field

The present disclosure relates to a display adjustment system and a display adjustment method for media players.

2. Description of Related Art

A conventional media player cannot customize the display of media for viewing, for example, viewing at different angles. In other words, when the media player is set or held at different angles, users need to view the display at different and sometimes awkward angles to see a clear display. User satisfaction is therefore reduced.

### BRIEF DESCRIPTION OF THE DRAWINGS

FIG. 1 is a schematic block diagram of an exemplary embodiment of a display adjustment system including a storage system, the display adjustment system is connected to a media player.

FIG. 2 is a schematic block diagram of the storage system of FIG. 1.

FIGS. 3A-3C is schematic diagrams of the media player showing three different states.

FIGS. 4A and 4B are schematic diagrams of a display of the media player of FIG. 1, showing two different states.

FIG. 4C is a schematic diagram of the display of the media player.

FIG. 5 is a flowchart of an exemplary embodiment of a display adjustment method for the display of a media player.

### DETAILED DESCRIPTION

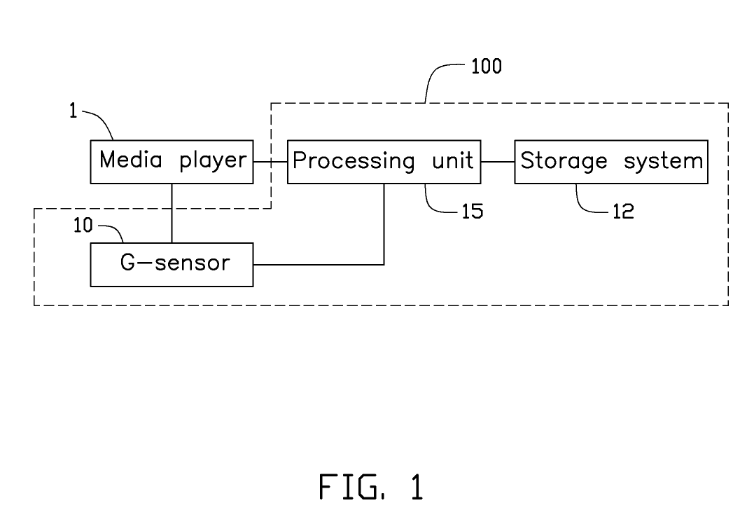

Referring to FIG. 1, an exemplary embodiment of a display adjustment system 100 includes a gravity sensor (G-sensor) 10, a storage system 12, and a processing unit 15. The display adjustment system 100 is operable to adjust an image displayed by a media player 1 according to the angle of the media player 1.

The G-sensor 10 is mounted to the media player 1, to detect motion in the media player 1.

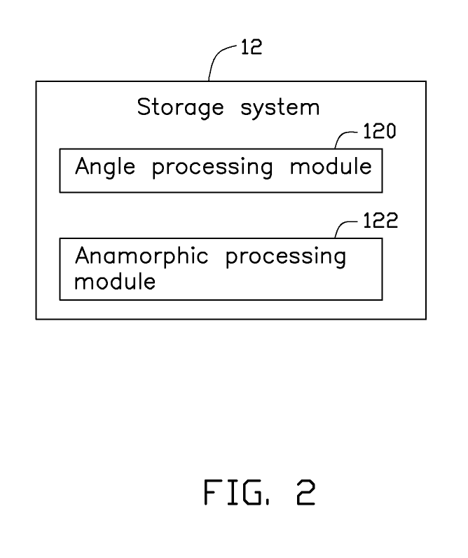

Referring to FIG. 2, the storage system 12 includes an angle processing module 120 and an anamorphic processing module 122. The angle processing module 120 and the anamorphic processing module 122 may include one or more computerized instructions which are executed by the processing unit 15.

The angle processing module 120 receives input from the G-sensor 10 and obtains an angle of inclination of the media player 1 corresponding to a datum plane. It is noteworthy that the angle processing module 120 calculates and compares voltages of the G-sensor 10 corresponding to the position of the media player 1 relative to the datum plane to obtain an angle of inclination of the media player 1.

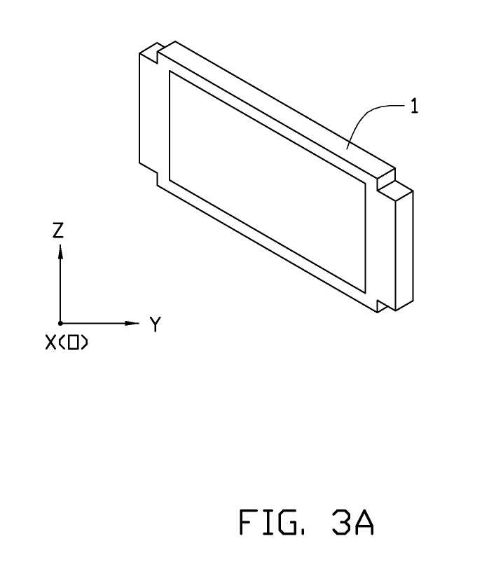

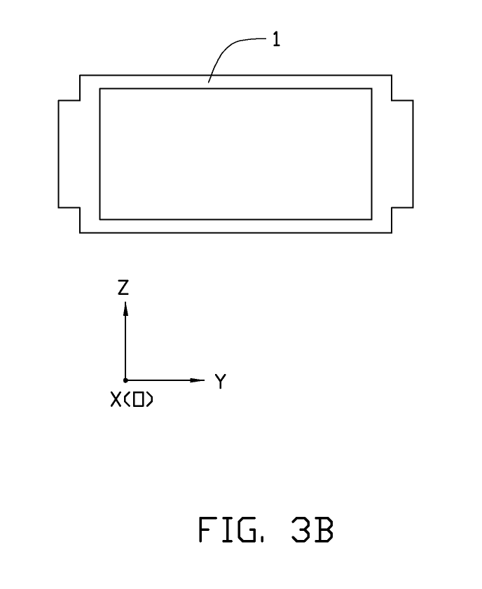

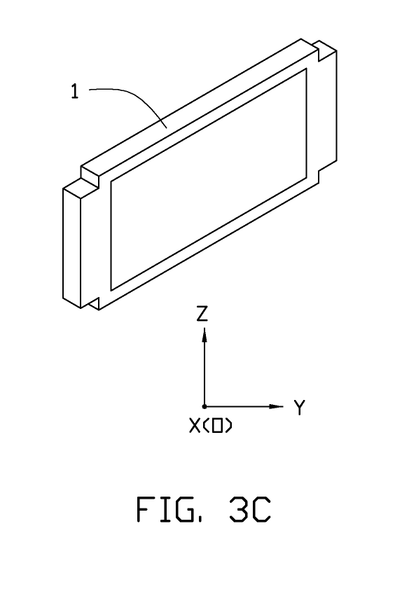

Referring to FIGS. 3A-3C, an angle of 135 degrees is between the media player 1 under a first state and a datum plane YOZ shown in FIG. 3A. An angle of 0 degrees is between the media player 1 under a second state and the datum plane YOZ shown in FIG. 3B. An angle of 45 degrees is between the media player 1 under a third state and the datum plane YOZ shown in FIG. 3C.

The anamorphic processing module 122 receives the angle of inclination of the media player 1 relative to the datum plane from the angle processing module 120, and correspondingly adjusts the image. The adjusted image is displayed by the media player 1.

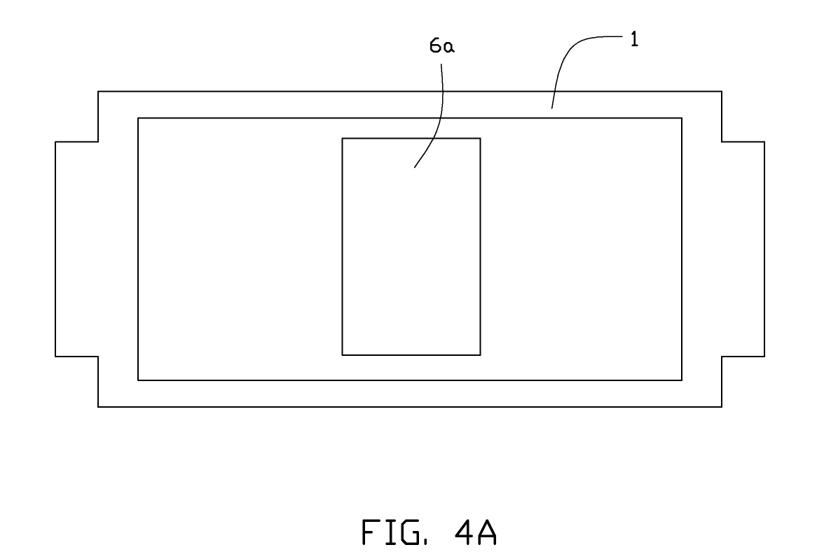

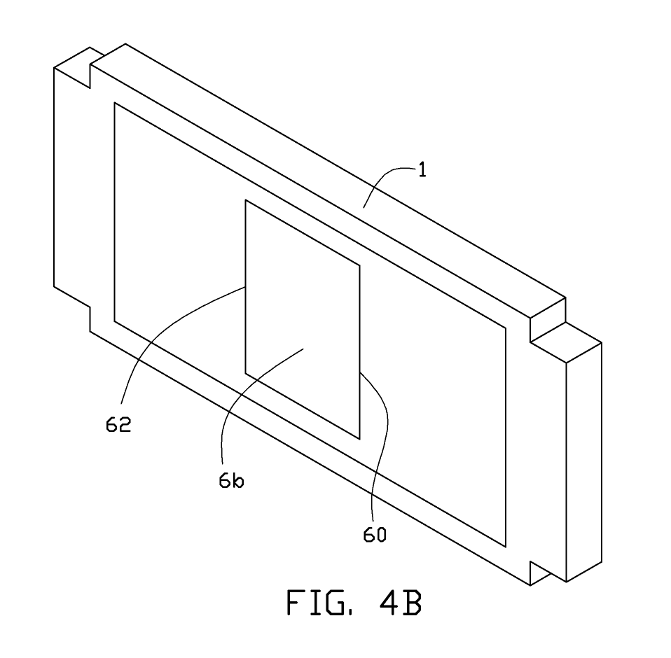

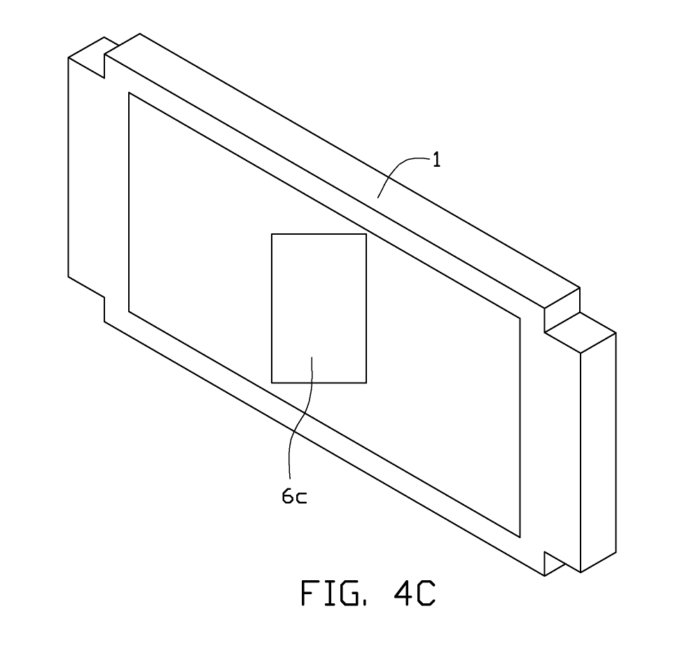

Referring to FIGS. 4A and 4B, depicted is a display of the media player 1 being viewed as image 6a in FIG. 4a, when a user directly faces the media player 1.

When the media player 1 is inclined, the viewing angle of the user also needs to change. At this time, the display is shown as an image 6b in the FIG. 4B.

The angle processing module 120 receives input from the G-sensor 10 and obtains an inclination angle of 135 degrees as shown in FIG. 4B relative to the datum plane YOZ. The anamorphic processing module 122 extends a side 60 of the image 6b, and shortens another side 62 of the image 6b, to make the side 60 equal to the side 62 in length. At this time, the user can clearly view the image 6c as shown in FIG. 4C. As a result, the user can view the same image no matter what angle the media player 1 holds.

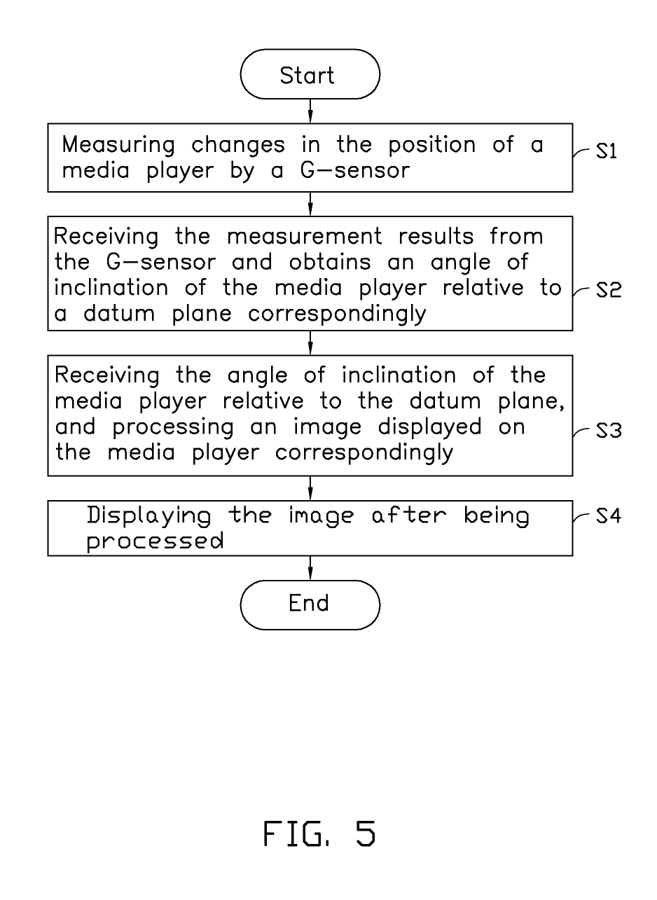

Referring to FIG. 5, an exemplary embodiment of an adjustment method includes the following steps.

In step S1, the G-sensor 10 measures changes in the position of the media player 1.

In step S2, the angle processing module 120 receives the measurement results from the G-sensor 10 and correspondingly obtains the angle of inclination of the media player 1 relative to a datum plane. It is noteworthy that the angle processing module 120 calculates and compares measurements from the G-sensor 10 when the media player 1 is parallel with the datum plane and when the media player 1 is angled relative to the datum plane, to obtain the angle of inclination of the media player 1. For example, as shown in FIG. 3A, the angle between the media player 1 under the first state and the datum plane YOZ is 135 degrees. As shown in FIG. 3B, the angle between the media player 1 under the second state and the datum plane YOZ is 0 degrees. As shown in FIG. 3C, the angle between the media player 1 under the third state and the datum plane YOZ is 45 degrees.

In step S3, the anamorphic processing module 122 receives the angle of inclination of the media player 1 relative to the datum plane from the angle processing module 120, and correspondingly processes the image displayed on the media player 1. In the embodiment, it can be understood that the anamorphic processing module 122 adjusts a size of the image according to the angle of inclination of the media player 1 relative to the datum plane.

In step S4, the media player 1 displays the image processed by the anamorphic processing module 122.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A display adjustment system for adjusting an image displayed by a media player, the adjustment system comprising:
a sensor mounted to the media player, to detect changes in position of the media player and output measurement results correspondingly;
a processing unit; and
a storage system connected to the processing unit and storing a plurality of modules to be executed by the processing unit, wherein the plurality of modules comprises:
an angle processing module to receive the measurement results and thereby obtain an angle of inclination of the media player corresponding to a datum plane; and
an anamorphic processing module to receive the angle of inclination of the media player, and correspondingly process the image, wherein the processed image is displayed by the media player.

2. The adjustment system of claim 1, wherein the sensor is a gravity sensor.

3. The adjustment system of claim 1, wherein the anamorphic processing module adjusts a size of the image according to the inclination of the media player.

4. A display adjustment method comprising:
measuring changes in position of a media player under measurement of a sensor mounted to the media player, and converting the changes to measurement results;
processing the measurement results to obtain an angle of inclination of the media player corresponding to a datum plane;
processing an image according to the angle of inclination of the media player; and
displaying the processed image by the media player.

5. The adjustment method of claim 4, wherein the sensor is a gravity sensor.

6. The adjustment method of claim 4, wherein the step of processing an image according to the angle of inclination of the media player comprises:
adjusting a size of the image according to the angle of inclination of the media player.
